(19) United States
(12) Patent Application Publication
(10) Pub. No.: US 2022/0227920 A1
(43) Pub. Date: Jul. 21, 2022

(54) ARTICLE MADE OF CONGLOMERATE MATERIAL, COMPOSITE ASSEMBLY COMPRISING SUCH ARTICLE AND METHOD FOR MANUFACTURING THE ARTICLE MADE OF CONGLOMERATE MATERIAL

(71) Applicant: Luca Toncelli, Bassano del Grappa (VI) (IT)

(72) Inventor: Luca Toncelli, Bassano del Grappa (VI) (IT)

(21) Appl. No.: 17/619,536

(22) PCT Filed: Jun. 23, 2020
(86) PCT No.: PCT/IB2020/055908

§ 371 Date: Dec. 15, 2021

(30) Foreign Application Priority Data
Jun. 27, 2019 (IT) 102019000010329

(51) Int. Cl. C08G 59/32; C08K 7/28; C08K 7/26; C08K 3/36; C08G 59/42; C08J 5/12; B32B 7/12; B32B 9/00; B32B 27/38; B32B 27/06; B32B 27/12; B32B 5/02; B32B 27/18; B32B 15/20; B32B 15/092

(52) U.S. Cl. CPC C08G 59/32; B32B 2264/1021; C08K 7/26; C08K 3/36; C08G 59/4238; C08J 5/12; B32B 7/12; B32B 9/002; B32B 27/38; B32B 27/06; B32B 27/12; B32B 5/02; B32B 5/028; B32B 27/18; B32B 15/20; B32B 15/092; C08J 2363/00; B32B 2262/106; B32B 2262/0269; B32B 2607/00; C08K 7/28

(57) ABSTRACT

An article made of conglomerate material comprising an aggregate comprising granules of expanded glass or expanded ceramic/clay defining between them inter-granular cavities and a binding resin. The binding resin is present in the minimum amount required to coat the granules of expanded glass or expanded ceramic/clay and the inter-granular cavities contain only air and are devoid of filling material. The binding resin is present in an amount equal to about 6-16% of the volume of the article and is a thermosetting resin obtained by means of reaction between an epoxidized unsaturated fatty acid triglyceride and a carboxylic anhydride in the presence of a catalyst.

The present invention relates to the production of articles made of conglomerate material and in particular the production of articles from a mix comprising granules and a resin.

For some time a method for the manufacture of compact and non-porous articles, preferably in slab form, known also as Bretonstone® technology, has been known, wherein an initial mix consisting of granular material with a selected particle size, a filler in powder form and a hardening resin is prepared.

Preferably the granular material is a stone material or inorganic stone-like material and the resin is chosen from the group comprising polyester, acrylic, epoxy, polyurethane and other resins.

The mix is deposited on a temporary support or on a mould and is subjected to a vacuum compression step, with the simultaneous application of a vibratory movement at a predetermined frequency.

Then the article is subjected to a resin hardening step, at the end of which the article has the desired mechanical characteristics. The resultant slab is then subjected to the successive finishing steps (sizing, smoothing, polishing and the like).

Alternatively or in addition, the mix may contain an expanded granular material, such as expanded glass or expanded clay, and/or a filler which is also composed of an expanded material. This latter composition helps reduce the specific weight of the finished article, which is in any case compact and non-porous.

IT1350446 discloses a method for manufacturing compact and non-porous articles made of conglomerate material from an expanded granular material, such as expanded glass and expanded clay.

Optionally, the articles made of conglomerate material thus obtained may be combined with a cladding panel or sheet which are made of a material which may also be different from the material of the article.

In this configuration it is necessary for the article and the cladding panel to have similar thermal expansion coefficients, so as to avoid distortions associated with variations in temperature.

Owing to the use of polyester, acrylic, epoxy and polyurethane resins it is possible to obtain high-quality articles with specific characteristics which distinguish them from conventional products.

In particular, the most widely used articles are those formed by conglomerate material containing polyester resins diluted with a styrene-containing solvent, which allow important technical characteristics to be obtained, besides being particularly low-cost.

One drawback of these known solutions consists in the fact that the article obtained with a solvent polyester resin tends to yellow when subjected to a heating step or to ultraviolet rays.

It is evident that this drawback has an effect on the aesthetic characteristics of the article, in particular in the case of articles to be applied as external cladding for buildings.

Another drawback of these known solutions consists in the fact that the presence of the monomer styrene as reactive solvent contained in the resin, and therefore in the mix, poses various environmental and health problems during the production of the articles, associated with its harmful nature and the risk of explosion due to its high volatility.

The use of styrene in the production process, in fact, requires the presence of plants for capturing and eliminating the particularly sophisticated and costly vapours in order to comply with the increasingly more severe regulations.

Furthermore, in the case of bicomponent resins, which have moreover a cost about four times that of the polyester resins, making them inconvenient from a cost point of view, there is a further drawback arising from the fact that these resins tend to harden also at room temperature before completion of the process for production of the article and to be deposited on the various parts of the plant, creating incrustations.

This drawback results in the need for frequent maintenance of the plant and therefore results in an increase in the overall production time.

A further drawback consists in the fact the expanded granular material allows only a limited reduction of the density of the articles, which therefore have a weight which is in any case significant. For example, the density of the articles thus made may be between 0.9-1.1 g/cm³. This drawback is of particular significance in the furnishing and building sectors, where the articles must be moved in order to be positioned in the user location.

In order to overcome at least partially these drawbacks, methods have been developed for the manufacture of articles made of conglomerate materials where resins different from those indicated above are used, for example resins derived from raw materials which are ecological and/or of renewable—in particular plant—origin, and do not contain styrene.

An example of these methods is described in EP2027077 which envisages the use of a resin formed by means of reaction between at least one epoxidized triglyceride and at least one carboxylic anhydride.

As regards the first component mentioned above, a number of suitable observations are made below.

By their nature, fatty acids are nearly always bound to an alcohol, namely glycerol, to form triglycerides and are divided into saturated fatty acids and unsaturated fatty acids which are in turn divided into monounsaturated and polyunsaturated fatty acids.

If the triglycerides are formed mainly by saturated and/or monounsaturated fatty acids, then these compounds are solid at room temperature and are referred to as fats and in particular are of animal origin.

If the triglycerides are formed mainly by unsaturated, monounsaturated and/or polyunsaturated fatty acids, then these compounds are liquid at room temperature and are referred to as oils and in particular are of plant origin.

These compounds have linear, but winding molecules owing to the double bonds along the carbon chain of the fatty acids. For use in the method described in EP2027077 these oils are subjected to a reaction for epoxidation of the double bonds (reaction well-known per se).

Furthermore, the chemical nature (aliphatic or aromatic) of the anhydride influences the operating parameters and consequently also the final characteristics of the resin obtained.

The anhydride used in the method described in EP2027077 is chosen from the group which comprises pyromellitic anhydride, maleic anhydride, succinic anhydride, hexahydrophthalic anhydride, phthalic anhydride, anhydride of norbornene dicarboxylic acid, adipic anhydride, glutaric anhydride, methylphthalic anhydride, 1,2-cyclohexyldicarboxylic anhydride, 3-methyl-1,2-cyclohexyldicarboxylic anhydride, 4-methyl-1,2-cyclohexyldicarboxylic anhydride, mixture of 3-methyl-1,2-cyclohexyldicarboxylic and 4-methyl-1,2-cyclohexyldicarboxylic anhydrides, methyl-tetrahydrophthalic anhydride, tetrahydrophthalic anhydride, methyl-5-norbornene-2,3-dicarboxylic anhydride, dodecenyl-succinic anhydride and mixtures of the same.

Moreover, the method envisages the addition of a catalysis initiator or catalyst in the mixture of epoxidized fatty acids and anhydride, in order to reduce both the reaction times and the process temperatures.

In this method a filler in combination with the granular material is used to fill the inter-granular cavities, namely the interstitial spaces between the granules, so as to form compact and non-porous articles.

Therefore a drawback of this solution consists in the fact that the finished article has a relatively high specific weight, such that the method does not envisage the use of expanded granular material in the mix.

Another drawback of this solution aimed at providing a compact article arises from the fact that the method for manufacture of the articles necessarily requires a step of applying the vacuum at the same time as compaction, in order to compact the granular material and the filler together.

This in fact results in a greater complexity both of the method and of the plant and an increase in the overall processing time.

One object of the present invention is to provide an article made of conglomerate material and a method for the manufacture thereof which are able to overcome the aforementioned drawbacks.

In particular, the main object of the present invention is to provide an article made of conglomerate material which has a significantly lower specific weight compared to the articles known in the sector.

A further object of the present invention is to provide an article made of conglomerate material in which the value of the linear thermal expansion coefficient is similar to that of the stone material compounds bonded with a resin.

Another object of present invention is to provide an article made of conglomerate material which has a mechanical strength sufficient to allow it to be used in the architectural and building sectors and which is not particularly costly.

The main objects described above are achieved with an article made of conglomerate stone material according to Claim 1, with a composite assembly according to Claim 14, and with a method for manufacturing the article according to Claim 17.

A peculiar characteristic of this article, which is made using expanded glass or ceramic/clay granules, consists in the fact that it is not compact, but porous and comprises interstitial cavities between the granules containing only air and therefore devoid of filling material. These cavities will be indicated in the remainder of the description by the expression “inter-granular cavities”.

The article according to the present invention does not envisage the use of paste (binder+filler) which on average represents about 20-30% of the overall volume of the article, for filling of the inter-granular cavities.

In the preferred embodiment of the present invention the article is made of conglomerate material and has a slab-like form. Conveniently, the slab-like article is obtained from a mix deposited on a mould or on a temporary support.

However, the article may also be made in the form of a block, using a formwork instead of a mould for deposition of the mix. In this case the slabs may be obtained by means of successive sawing of the block in a known manner.

The conglomerate article is made from an aggregate of inert material in the form of expanded—and therefore light—granules which have a selected particle size range.

Advantageously, the granules consist of expanded glass or expanded ceramic/clay and are bonded together by means of a binding resin which may be thickened by means of the addition of an additive, such as a fine powder, which preferably consists of micronized colloidal silica with a thixotropic effect, also known by the tradename “Aerosil”.

The granules of expanded glass or expanded ceramic/clay, while they have an impermeable surface, have internal cavities which help lighten further the article and reduce the specific weight thereof compared to the articles known in the sector.

Preferably, the expanded granules have a particle size of between 0.1 and 8.0 mm and are non-permeable, spongy, spheroidal granules which have an average density of between 0.35 and 0.5 g/cm³.

In the present description, the term “spongy” indicates an element having a porous and non-compact internal structure.

The granular material may also have different particles sizes and densities, provided that it is able to maintain its spongy internal structure as indicated above.

Moreover, the resin is preferably a resin of the thermosetting type and the article is obtained by means of compaction, preferably vibro-compression; the manufacturing method will be described in detail in the remainder of the present description.

The binding resin is present in a minimum amount necessary for coating the granules. This amount, which is equal to about 6-16% of the volume of the article, does not allow the inter-granular cavities to be filled and saturated, so that they remain full of air.

It should be noted that the binding resin, which may be thickened with a fine powder which consists preferably of micronized colloidal silica, forms a thin adhesive layer at the interface between the expanded granules, which plays a decisive part for the value of the linear thermal expansion coefficient to be obtained. In particular, this configuration results in a linear thermal expansion coefficient of the article equal to about 18-28 μm/m° C.

The amount of binding resin may be more than 8% of the volume of the article; in particular the amount of binding resin may be equal to about 8-16% of the volume of the article.

In accordance with a further embodiment, the amount of resin may be equal to about 6-10% of the volume of the article.

Conveniently, since the article is porous, the inter-granular cavities are devoid of filling material and are full of air; because of this characteristic, it is impossible to use polyester resin since the oxygen would prevent optimum hardening thereof.

Moreover, the presence of air inside the expanded granules and inside the inter-granular cavities results in the article having a limited capacity to convey heat and makes the article an effective heat insulant.

This characteristic results in slow transmission of the heat during the heating phase following compaction, with the result that the core of the article heats up much longer after the skins.

Moreover, this characteristic prevents the use of a polyester resin since the catalytic hardening reaction of the latter generally results in a significant volumetric shrinkage and a violent reaction. These reactions may result in the formation of major tensions inside the article and a high risk of distortion and warping.

The configuration of the article indicated above moreover results in a reduction of the density of its structure, which may be advantageously in the range of 0.4-0.7 g/cm³, and therefore makes the article lighter than those which are known in the sector.

This advantage is particularly useful in the architectural and building sector, in particular during movement of the articles.

For the aforementioned purposes a bicomponent resin would be technically more suitable. However, this resin has a significant cost and is characterized by hardening already at room temperature, which complicates the processing and use thereof.

With the present invention, however, it has been noted that the use, as binding resin, of a thermosetting resin obtained by means of reaction between an epoxidized unsaturated fatty acid triglyceride and anhydride derived from a carboxylic acid in the presence of a catalyst is particularly advantageous.

This type of resin has a cost which is only 50-60% higher of the cost of a polyester resin and has a non-violent hardening reaction, with very low volumetric shrinkage.

For this reason, with the resin according to the present invention it is possible to obtain a well-hardened flat article without internal tension.

Preferably, the anhydride used for the production of the resin according to the present invention is a cycloaliphatic anhydride, such as methylhexahydrophthalic anhydride. Alternatively different anhydrides may be used, being chosen from the group comprising maleic anhydride, succinic anhydride, hexahydrophthalic anhydride, phthalic anhydride, norbornene dicarboxylic acid anhydride, adipic anhydride, glutaric anhydride, methylphthalic anhydride, 1,2-cyclohexyldicarboxylic anhydride, 3-methyl-1,2-cyclohexyldicarboxylic anhydride, 4-methyl-1,2-cyclohexyldicarboxylic anhydride, mixture of 3-methyl-1,2-cyclohexyldicarboxylic anhydride and 4-methy-l-,2-cyclohexyldicarboxylic anhydride, methyl-tetrahydrophthalic anhydride, tetrahydrophthalic anhydride, methyl-5-norbornene-2,3-dicarboxylic anhydride, dodecinyl-succinic anhydride.

Moreover, the anhydride may consist of a mixture of anhydrides which are different from each other.

Advantageously, the triglyceride may consist of an epoxidized linseed oil and the catalyst may consist of 1-methylimidazole.

These components, although preferred, are only examples and must not be regarded as limiting the scope of protection of the present invention.

For example, the triglyceride may also consist of a mixture of triglycerides of oils of plant origin, such as soya oil, sunflower oil, palm oil and tallow oil.

Moreover, the catalyst may also be chosen from the group which comprises other aromatic amines C₃-C₆ besides 1-methylimidazole, in particular, the aromatic diamines C₃-C₆.

Advantageously, this particular resin does not tend to yellow, both during the catalytic hardening step at a predetermined temperature and in particular when it is exposed to UV radiation.

As already indicated above, the resin may also comprise a thickening additive, such as a fine powder, which consists preferably of micronized colloidal silica.

This fine powder consisting preferably of micronized colloidal silica is suitable for thickening the resin and increasing its viscosity, with a possible thixotropic effect, and can be added to the resin in an amount by weight of between 5% and 15%.

The fine micronized colloidal silica powder added to the resin makes the mixture consistent and homogeneous, preventing separation of the components, in particular during the deposition of the mix on the mould and the subsequent compaction step.

The thermosetting resin may also comprise a silane with the function of increasing adhesion to the inert material.

Silanes suitable for the resin of the present invention may be chosen from the group which comprises trialkoxysilanes or trimethoxysilanes.

Advantageously the composition of the resin may advantageously comprise further additives, e.g. additives assisting catalysis of the resin or antibacterial additives of a type known per se.

The present invention also relates to a composite assembly comprising the slab-like article described above combined with a cladding panel, which is preferably thin so as not to make the assembly heavy and is made of a material different from the conglomerate material of the article.

The article made of conglomerate material and the panel can be joined together by means of a suitable glue or adhesive, in a manner known per se.

Preferably, the panel and the article have a linear thermal expansion coefficient of the same order of magnitude; in particular, the linear thermal expansion coefficients of the panel and the article may be between 22 and 27 μm/m° C. This latter characteristic prevents distortions of the composite assembly when the temperature changes.

In particular, the panel may be made with a stone material combined with resin or a metallic material such as aluminium, or with a different material, and may act as a cladding and form a visible surface of the composite assembly.

It is also possible to provide the composite assembly with greater mechanical strength, by applying a high-strength element to the non-visible rear side of the light slab-like article, and therefore on the opposite side to the cladding panel; for example, it is possible to apply a glass or aramid or carbon fibre mesh or fabric by means of an adhesive resin.

In this case, the lightweight article is placed between the cladding panel and the high-strength element.

The present invention relates furthermore to a method for manufacturing the article made of conglomerate material in accordance with the description provided above.

The method comprises the following steps:

(a) preparation of an initial mix containing granules and a thermosetting binding resin, which may have an added thickening agent such as a very fine powder, preferably consisting of micronized colloidal silica, in the quantity strictly needed to surround the granules; the resin is designed to be formed by reaction between an epoxidized unsaturated fatty acid triglyceride and carboxylic anhydride in the presence of a catalyst;

(b) deposition of the mix on a temporary support or mould;

(c) compaction of the mix;

(d) hardening of the resin at a predetermined temperature to obtain the article made of conglomerate material.

The granular material used for the preparation of the initial mix consists of expanded glass or ceramic/clay granules of the type described above with reference to the article.

Advantageously, the compaction step c) is carried out by vibro-compression of the mix; moreover, the catalyst may be 1-methylimidazole and the predetermined temperature for hardening the resin is between 80° C. and 180° C. Preferably, the mould or temporary support has the same dimensions as those of the article to be obtained

The method described above does not require a vacuum application step, as in the case of the methods known in the sector, since the resin is present at the interface between the expanded granules and only air is present in the inter-granular cavities, with no filling material being provided.

In addition, the thermosetting binding resin has a controlled viscosity owing to the contribution of the fine powder of micronized colloidal silica which is added to the resin.

This configuration makes the structure of the product particularly light, with a lower specific weight and density.

With reference to the article described above, the binding resin is present in a quantity equal to about 6-16% of the volume of the article and is formed by means of reaction between an epoxidized unsaturated fatty acid triglyceride and carboxylic anhydride in the presence of a catalyst.

Conveniently, the amount of binding resin may be greater than 8% of the volume of the article and preferably equal to about 8-16% of the volume of the article.

In accordance with a further embodiment, the amount by weight of binding resin is equal to about 6-10% of the volume of the article.

It is now clear from the above description how the article made of conglomerate material, the method of manufacturing the article and the composite assembly are advantageously able to achieve the predefined objects.

In particular, it is clear how the combination of a particular resin, designed to be formed by means of reaction between an epoxidized triglyceride and a carboxylic anhydride, and an expanded granular material, without the addition of filling material inside the inter-granular cavities, is able to produce a solid article made of conglomerate material with a low specific weight and with a linear thermal expansion coefficient of the desired value.

It should be pointed out that the article obtained by means of the method according to the present invention does not comprise any paste (resin+filler) for filling the inter-granular cavities and therefore has a low specific weight.

This configuration is able to avoid having to perform a vacuum application step in order to manufacture the finished article and helps further reduce the specific weight of the article.

Furthermore, it helps reduce significantly the complexity and the cost of the production plant. Obviously, the above description of embodiments applying the innovative principles of the present invention has been provided by way of example of these innovative principles and must therefore not be regarded as limiting the scope of protection claimed herein.

In particular, the characteristic features of the solutions shown here may be used only partially depending on the specific needs.

1. Article made of conglomerate material comprising:
an aggregate comprising granules of expanded glass or expanded ceramic/clay defining inter-granular cavities between them;
a binding resin;
characterized in that said binding resin is present in the minimum amount required to coat the granules of expanded glass or expanded ceramic/clay and in that the inter-granular cavities contain only air and are devoid of filling material,
said binding resin being present in an amount equal to about 6-16% of the volume of the article and being a thermosetting resin obtained by means of reaction between an epoxidized unsaturated fatty acid triglyceride and a carboxylic anhydride in the presence of a catalyst.

2. Article according to claim 1, characterized in that the amount of binding resin is equal to about 8-16% of the volume of the article.

3. Article according to claim 1, characterized in that the amount by weight of binding resin is more than 8% of the volume of the article.

4. Article according to claim 1, characterized in that the amount of resin is equal to about 6-10% of the volume of the article.

5. Article according to claim 1, characterized in that said granules of expanded glass or expanded ceramic/clay have a selected particle size range.

6. Article according to claim 5, characterized in that said granules of expanded glass or expanded ceramic/clay have a size within a particle size range of between 0.1 and 8.0 mm.

7. Article according to claim 5, characterized in that the granules of expanded glass or expanded ceramic/clay are non-permeable, cavernous, spheroidal granules which have an average density of between 0.35 and 0.50 g/cm³.

8. Article according to claim 1, characterized in that said carboxylic anhydride consists of methylhexahydrophthalic anhydride.

9. Article according to claim 1, characterized in that a thickening agent is added to said binding resin.

10. Article according to claim 9, characterized in that said thickening agent is a fine powder.

11. Article according to claim 10, characterized in that said fine powder consists of micronized colloidal silica.

12. Article according to claim 11, characterized in that said fine powder consisting of micronized colloidal silica is added to the resin in an amount by weight of between 5% and 15%.

13. Article according to claim 1, characterized in that said binding resin comprises a silane.

14. Composite assembly comprising:
an article made of conglomerate material according to one or more of claims 1 to 13, manufactured in the form of a slab;
a cladding panel made of a material different from the conglomerate material, said article and said panel being joined together, wherein said panel and said article have a linear thermal expansion coefficient of the same order of magnitude.

15. Assembly according to claim 14, characterized in that it comprises a high-strength element applied to the non-visible side of the article made of conglomerate material and therefore on the opposite side to the cladding panel.

16. Assembly according to claim 15, characterized in that said high-strength element is formed by a carbon or aramid or glass fibre fabric or mesh using a binding resin.

17. Method for the production of articles made of conglomerate material, comprising the following steps:
a) preparation of an initial mix containing granules of expanded glass or expanded ceramic/clay and a binding resin to which a thickening agent may be added;
b) deposition of said mix on a temporary support or in a mould;
c) compaction of said mix;
d) hardening of said binding resin at a predetermined temperature so as to obtain said conglomerate material;
characterized in that said binding resin is present in the minimum amount required to coat the granules and in that the inter-granular cavities contain only air and are devoid of filling material,
said binding resin being present in an amount equal to about 6-16% of the volume of the article and being formed by means of reaction between an epoxidized unsaturated fatty acid triglyceride and a carboxylic anhydride in the presence of a catalyst.

18. Method according to claim 17, characterized in that said step c) is performed by means of vibro-compression.

19. Method according to claim 17, characterized in that the amount of binding resin is equal to about 8-16% of the volume of the article.

20. Method according to claim 19, characterized in that the amount of binding resin is more than 8% of the volume of the article.

21. Method according to claim 17, characterized in that the amount of resin is equal to about 6-10% of the volume of the article.
